(19) United States
(12) Patent Application Publication
(10) Pub. No.: US 2015/0073316 A1
(43) Pub. Date: Mar. 12, 2015

(54) Face Masks and Software/Application for Activating Nitric Oxide Production in Sinuses

(71) Applicant: Anthonius Fredericus Maria Bende, Amsterdam (NL)

(72) Inventor: Anthonius Fredericus Maria Bende, Amsterdam (NL)

(21) Appl. No.: 14/477,092

(22) Filed: Sep. 4, 2014

(30) Foreign Application Priority Data
Sep. 7, 2013 (NL) 1040380

(51) Int. Cl. A61H 23/00

(52) U.S. Cl. CPC A61H 23/00; A61H 2201/1604
USPC 601/46

(57) ABSTRACT

The invention relates to a face mask including a body adapted to fit over at least a part of the face of a user, wherein the body has at least a top side, a bottom side and a plane of reference extending in a vertical direction from the top side to the bottom side; at least one protrusion for contacting the face of the user, which at least one protrusion is arranged at the body; a vibration mechanism arranged in vibrating contact to the body, wherein the vibrations of the vibration means are transmitted by the body to the at least one protrusion; and a securing mechanism arranged to the body for securing the body to the face of the user.

### CROSS-REFERENCE TO RELATED APPLICATION

This application claims priority to Netherlands Patent Application No. 1040380 filed Sep. 7, 2013, the disclosure of which is hereby incorporated in its entirety by reference.

### BACKGROUND OF THE INVENTION

1. Field of the Invention

The invention relates to a face mask.

2. Description of Related Art

Since 1998, we do know the function of NO (nitric Oxide) in our body and mind. Since 2002, 2003 we do know also that the sinuses, are more then only cavities for warming and filtering the air, before the air reach the lungs. Now we know that the sinuses are major producers of the important molecule/gas NO (Nitric Oxide) or iNO (Inhaled nasal Nitric Oxide) what also can be described as a vital for the health for body and mind as neurotransmitter.

It is known that there is a need by man for NO (nitric oxide), especially by people who are used to breathe through the mouth often or are mouth breathers for a long time. Only stimulating the sinuses for higher production in and around through portions of the head, neck and nose by natural humming, is not strong enough and needs a long time to start function. Also making the needed humming sound can be tiresome as it must be done for a long period of time to take effect in time.

As many researches show, and medical backed-up, a higher amount of NO (nitric oxide) can be important for many health issues for body and mind, we also know, that the exact period of vibration like humming is important to follow, as this creates the quantity of NO (nitric oxide) gases.

A number of devices for massaging the face are known, such as WO 2013/009119, which describes a flexible mask, which is provided on the inside with a plurality of vibrating elements. These vibrating elements are in direct contact with the skin of the user.

Another publication, DE 10 2011 016522, relates to a rigid face mask, in which a plurality of ultrasonic elements are arranged. These ultrasonic elements are used to stimulate the skin of the user. Furthermore, electrodes could be arranged, also for stimulating the skin.

These known devices are complex due to the plurality of active elements, i.e. vibration elements, and not intended nor suitable for stimulating the production of nitric oxide.

Accordingly it is an object of the invention to reduce the above mentioned disadvantages.

### SUMMARY OF THE INVENTION

This object is achieved with a face mask comprising:

a body adapted to fit over at least a part of the face of a user, wherein the body has at least a top side, a bottom side and a plane of reference extending in a vertical direction from the top side to the bottom side;

at least one protrusion for contacting the face of the user, which at least one protrusion is arranged at the body;

vibration means arranged in vibrating contact to the body, wherein the vibrations of the vibration means are transmitted by the body to the at least one protrusion; and

securing means arranged to the body for securing the body to the face of the user.

The face mask according to the invention uses vibration means of which the vibrations are transmitted via the body to the at least one protrusion.

With the face mask according to the invention the correct places (locations) where the sinuses are located are activated and thus production of nitric oxide is more intense and faster.

When the user inhales through the nose, the produced nitric oxide, stimulated by the face mask according to the invention, is absorbed by the body and important for the successful effect of the NO (nitric oxide) on the body and mind. As many researches show Nitric Oxide works as a strong vasodilator what reflects positive on a number of serious illnesses like Hypertension, high cholesterol, ED, asthma, arthritis, low immunity, infections caused by germs, viruses and or fungi and more without the use of any medicine taken.

In a preferred embodiment of the face mask according to the invention at least two primary protrusions are arranged each on one side of the plane of reference and near the top edge of the body for contacting the frontal sinuses of the user.

In a further embodiment of the face mask according to the invention at least two secondary protrusions are arranged each on one side of the plane of reference and near the bottom edge of the body for contacting the maxillary sinuses of the user.

In yet a further preferred embodiment of the face mask according to the invention at least two tertiary protrusions are arranged each on one side of the plane of reference for contacting the ethmoid sinuses of the user.

The primary, secondary and tertiary protrusions are positioned such that the vibrations of the vibrating means are directed via the body to the locations where the sinuses of a user are located. The protrusions are in contact with the skin of the user such that the vibrations are transmitted in an optimal way from the vibration means to the sinuses.

Preferably, the plane of reference is the plane of symmetry.

The face of a user is typically symmetric over a vertical plane of symmetry, such that when designing a face mask, the symmetry is easily reflected in the face mask. It will also provide for an aesthetic appearance.

In a further embodiment of the face mask according to the invention the body is a rigid shell. Although other shapes for the body could be selected, such as a rod structure wherein the tips of the rods could be the protrusions, it provides more comfort for the user, if the body of the face mask according to the invention is embodied as a rigid shell, which can be worn over the face, similar to a ski mask or the like.

Preferably, the at least one protrusions is arranged on the inside of the shell.

The height of the at least one protrusion could be adjustable, such that the at least one protrusion can be adjusted to the specific shape of the user.

In yet another embodiment the body comprises at least one central opening for providing a free view by the user. The opening enables to user, to look around, while wearing the face mask.

In still a further preferred embodiment of the face mask according to the invention the primary protrusions are arranged between the at least one central opening and the top side. As a result, the primary protrusions will be in contact with the face of the user above the eyes, where the frontal sinuses are located.

In another embodiment of the face mask according to the invention the secondary protrusions are arranged between the at least one central opening and the bottom side. As a result, the secondary protrusions will be in contact with the face of the user, just below the eyes, where the maxillary sinuses are located.

Preferably, a bridge part is arranged extending over the central opening and preferably the tertiary protrusions are arranged on the bridge part.

Is this embodiment, the tertiary protrusions will be in contact with the portions of the face on opposite sides of the nose to stimulate the ethmoid sinuses.

It is furthermore preferred to have integrated nostril dilators what enhance an optimal production and transport of NO and the optimal benefit by inhaling air. When wearing the face mask, the integrated nostril dilators ensure a good opening of the nose, stimulating nose breathing.

The face mask according to the invention vibrates the face on the exact right positions of the face, where the sinuses are located, to enhance faster, (less treatment) and the highest production of NO possible in a more comfortable and correct way. The face mask according to the invention could preferably be provide with two, four, six, or more vibrating elements using an electronic control measuring system. The vibrating elements are precisely on the right spot in the face for optimal stimulation can be build in the mask also adjustable, meaning that the mask will fit every size face small or large. (A face mask for each type of physical condition, for which NO has a beneficial effect according to relevant studies, can be provided, for example one Hypertension, high cholesterol, ED, asthma, arthritis, low immunity, infections caused by germs, viruses and or fungi and more without the use of any medicine taken size fit all).

An electronic measuring system is measuring the length of working time as the vibration can be lower in time, (but not the frequency of the vibration) The frequency of the vibration should preferably not be less the 100 Hz. or not higher then 300 Hz., vibration per second, as this is the optimal frequency for the production of the NO in our sinuses, studies learned. The software of the electronic control can be build adjustable, when needed. Due to activating the exact spots, the production of NO is faster and higher and more comfortable. Also the controller and the software of this controller of this invention is able to increase or decrease the intensity of the vibrating elements, to ensure the right number of NO received.

With or by receiving vibration massages in general, the user will experience a relaxation feeling, and will be more or less forced to relax especially when light massage/vibration is taking place on the face. The light vibration of the humming face mask makes the user a kind of drowsy or sleeping. With this humming-mask invention a user can lay down on his or her back or side, while the vibrating is activating the exact spots/locations where the intense humming exists normally. This also is important as the insensitivity of the mask is also an activator of sleep hormones, what makes the user want to sleep also.

The face mask according to the invention gives everybody the opportunity to activate the NO from the sinuses in a relaxing way without the danger of drowsiness in different situations, where drowsiness is not advisable, due to the fact that the mask will force to close the eyes slowly and only can be used when we lay down or sitting in a relaxed way.

The time for producing NO with the face mask according to the invention, is much shorter due to activating the exact spots in the face. Therefore it also can be used in controlled environment, as in clinics, massage houses, doctor practices and hospitals, as the time of higher production of NO is important, as the time in a clinics, hospitals or massage houses is expensive. This can be achieved due to the fact that the right position in the face direct is activated, and not through the neck, the side of the scalp jaws, etc. The effect of this humming-mask invention is therefore more effective in the time available.

As many researches show that a higher amount of NO can be important for many health issues for body and mind, we also know, that the period of vibration like humming is important to follow, as this create the quantity and quality of NO gas. Not only is the frequency of the vibration itself important but also the length of time of the vibration. After a certain time of approximately 100 to 140 second, it is advisable to give the sinuses rest for a short time, approximately 180 seconds, to achieve a new start for new production of NO. By a constant and continue vibration, the level of quantity of NO will become stable and will come down 40 to 80%, and the released NO is not optimal.

This mask according to the invention preferably has integrated an electronic device that measures the exact time of vibration, and will fade in and out and switch on and off in a way for optimal release in combination in an optimal comfort.

Many people are breathing through the nose and mouth and mouth or nose alone. Nose breathing is a very important in relation to the present invention, as breathing through the mouth will bring not the desired result in inhaling the NO, activated by vibration. Only approximately 3 to 5% will reach the lungs when breathing through the mouth. Therefore breathing through the nose is highly important part of this invention, as activating of the sinuses alone, will not resulting in the desired effect. Nose breathing is a must and brings approximately 94% of the produced NO in to the lungs. This invention has integrated in the humming-mask/application invention a double nose dilator (for the left and the right nostril) advisable made from, (medical) silicone or from a different material than the mask with vibration elements is made from, but in both cases the nose dilator will be a significant element of this invention. Beside the function of breach the nostrils by using the dilators, the dilators can have also the function as a producer of “under pressure” that is needed for a sucking function on sinus Ostia, the connection between the cavities of the sinuses and the nostrils.

The locations of the (adjustable) vibration elements in the face mask are positioned in a way, that the nose/nostrils itself will preferably be free from direct contact of vibration. There are two reasons for this positions, one is that the nose must be free for using the nose dilator to place to achieve a free breathing as possibility with the needed under pressure, in a comfortable way, and two; the nose itself is highly sensitive and direct vibration to the nose and nostrils will activate the sneezing effect that what is not advisable and not comfortable.

The face mask according to the invention preferably operates on 1.5, 3, 4.5, 6, 12, or 24 volt, with a 500 to 3000 mA current low power, or direct from the power source, with the use of a connected power converter, from high to low power. This in case the power source will be different, and a low power is needed.

The face mask according to the invention can also be battery operated, as needed, volts and Amps are depending on the number and quality, and current of vibrating elements, quality of the engines, magnet or brush operated system and sources.

### BRIEF DESCRIPTION OF THE DRAWINGS

These and other features of the invention will be elucidated in conjunction with the accompanying drawings.

FIG. 1 shows schematically the locations of the sinuses.

FIG. 2 shows a schematic view of an embodiment of the face mask according to the invention.

FIG. 3 shows schematically the variable locations of the vibration elements

FIG. 4 shows a second embodiment of the face mask according to the invention.

FIG. 5 shows a third embodiment of the face mask according to the invention.

FIG. 6 shows a side view of a person wearing a fourth embodiment of the face mask according to the invention.

FIG. 7 shows the embodiment of FIG. 6 in frontal view.

FIG. 8 shows a fifth embodiment of the face mask according to the invention.

FIG. 9 shows a sixth embodiment of the face mask according to the invention.

FIG. 10 shows the inner side of the face mask according to FIG. 9.

### DESCRIPTION OF THE INVENTION

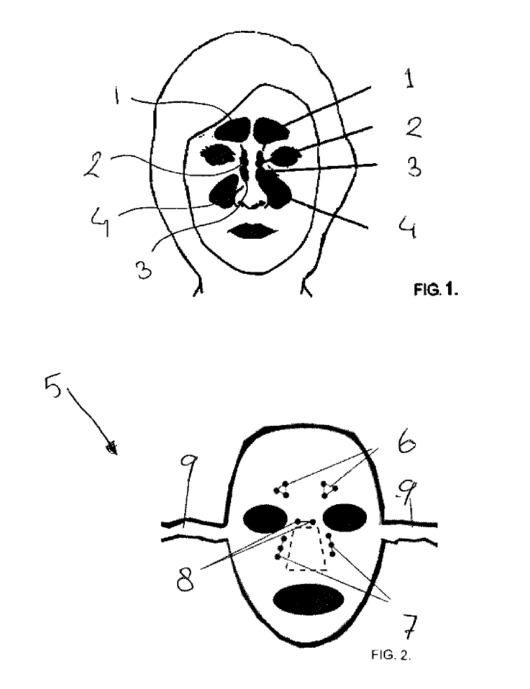

FIG. 1 shows schematically the sinuses in the head of a human being where the NO (nitric oxide) is produced. The location 1 is the location of the “frontal Sinuses” in the forehead, left and right. The “Ethmoid Sinuses” (left and right) are located at location 2. The “Sphenoid Sinuses” (left and right) are located at location 3 and the “Maxillary Sinuses” (left and right) are located at location 4.

This way we can determine the correct places. Locations 1 and 4, are the most important producers and need to be activated directly with one, two or three vibrator elements. A kind of drawing like this one will be used in the important explanation for the user.

FIG. 2 shows a first embodiment of a face mask 5 according to the invention, made from a plastic source, a silicone, or a textile or a combination. The mask can be produced in various models, like modern, vintage, sine fiction, face covered or partly covered. In all models the protrusions must be located in the right location on the sinuses. A vibrator (not shown) is attached to the mask, such that the vibrations can be transferred via the mask to the protrusions. The material must be suitable and comfortable and safe to place on the face/skin. The mask 5 can be provide with soft pink, glasses, or plastic to enhance the relaxing feeling in the start. The locations of the protrusions 6, 7, 8 placed in the mask are also pointed out in this drawing, and which will trigger the sinuses 1, 2, 3, 4. The protrusions 6, 7, 8 are preferably placed flexible and adjustable. A strap 9 is provided to fix the face mask 5 on the face of a user, such that it will not fall or slip off the head by movement. For this we can use magic tape, Velcro, rubber band, or other manners, and are not direct important for this invention, as the face mask according to the invention can be placed on the face with or without any increased attachment or platform, especially when it is used lying at the back.

In FIG. 3. we can follow the flexibility of the protrusions 6, 7, 8 for the right position. Protrusion 6 is fixed or can move around a ½ to ¾ inch in diameter, left right/higher and lower etc. This is the same for protrusions 7 and 8.

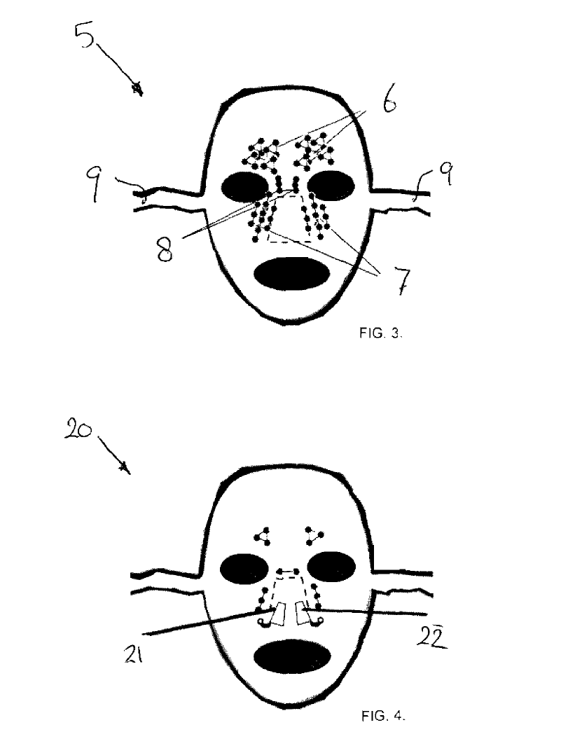

FIG. 4 shows a second embodiment of a face mask 20 according to the invention. We can see the integrated nose dilators 21, 22(round conic cylinders (nose cones), made of soft silicone. The nose dilators 21, 22 open the nostrils when blocked, for free air inhaling purposes through the nose and when needed to create an under pressure, to force open the connection canals form nostril to sinus. The silicone nose dilators 21, 22 with air restriction valve, are fixed in to the mask 20, and are revolving in a way that they are always available and easy to be placed in the nostrils while using the mask 20. Also the revolving attachment is flexible and can be made from silicone for hygienic purposes.

FIG. 5 shows a third embodiment of a face mask 30. The face mask 30 has nasal dilators 31, 32, in a flexible way, in case the attachment is not possible within the face mask, is produced of a material textile/plastic, or different material that that made permanent integration not possible.

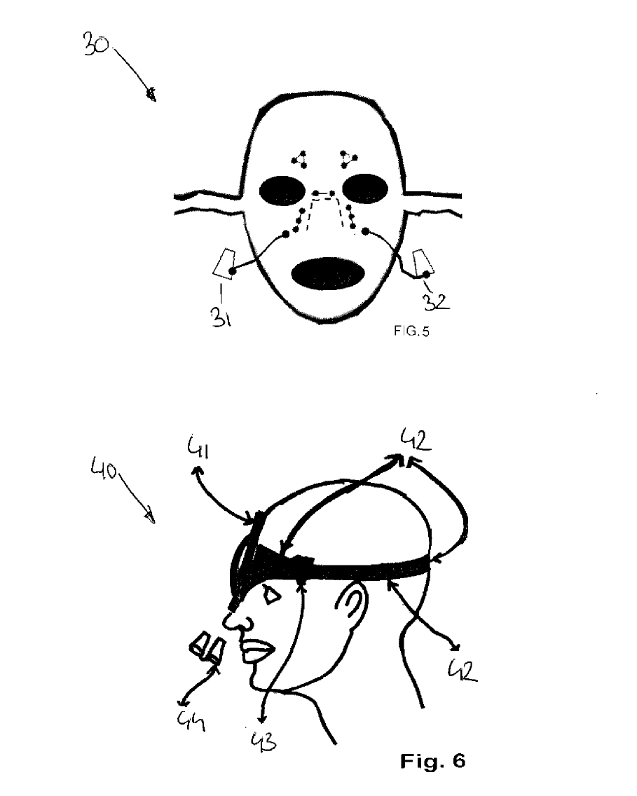

FIG. 6 shows a fourth embodiment of a face mask 40. The mobile face mask application (smart APP) as part of this invention; The application/software (smart APP) and attached method for activating NO nitric oxide, production by the use of an existing or attached vibration source using a intelligent (smart) mobile device 41. As stated above, the existing inventions on vibration elements for stimulating the sinuses, for the production of nitric Oxide, (NO), as far as we know, learned from several studies, are vibrating elements on the sinuses a replacement for Humming. Research learned, that Humming (vibration) will increase NO (nitric oxide) production 15 to 20 times higher, and sometimes even higher, than when man breath-in, in silence through the nose or mouth. With this invention people now can enhance their NO at serious low cost, and without any medicine, all individually (home use) by using their mobile intelligent device and the vibration function thereof and or attachment by the intelligent device 41 on using direct or using a attachment for activating in the face the exact positions, where the sinuses are located, to enhance faster and the highest production of NO (nitric oxide) possible in a short time. As researches show the enhanced NO (nitric oxide) production bring down the cost for many people who suffer from many kind of medical problems, like high blood pressure (hypertension) high cholesterol, etc.

Using a new or existing mobile intelligent device 41 as software/vibration device or only software device combined with attached vibrator mask 40, millions of people can access now in a cheap an fast way this application, to increase health to a high level, at a low cost. The intense vibrating/humming exist normally by humming with the voice (vocal cords), but is in time strenuous and because of that not done very often. This new invention extension including software app, gives everybody the opportunity to activate the NO (nitric oxide)in the sinuses in a relaxing and natural way without the danger of drowsiness and side effects, in different situations, where drowsiness is not advisable.

The present mobile application invention 40 is also based on the need of the use of NO (nitric oxide), especially by people who are usual to breathe through the mouth and not often enough through the nose, or by people who like or need to enhance their NO (nitric oxide) production in general like diabetes, as the intake of NO (nitric oxide) in general is mostly too low to zero. Stimulating the sinuses by vibrating for higher NO (nitric oxide) production prior intake/inhale in to the lungs, is highly healthy and medical advised, as NO (nitric oxide) has many positive influence on the body and mind.

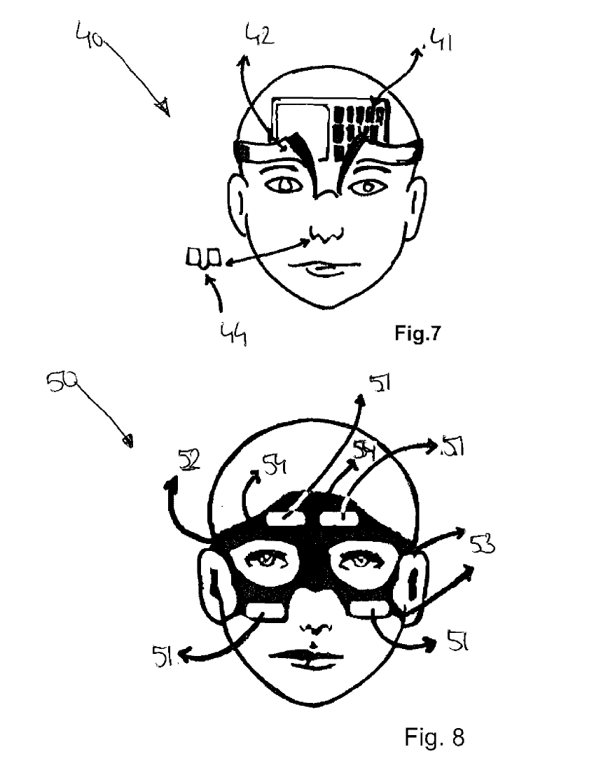

Besides the use of a face mask, as mentioned earlier in this patent, there are in this invention more apparatus, with a build in vibration option. This invention is a software application plus attached an external vibration element/mask 40, when needed, and method with vibration transmitter 41 what can be used on the front head of the user, using a mobile intelligent programmable device 41 like a mobile (smart) phone, a mobile game device, an IPod or pad, or other mobile device that is not yet known on the market, but what will include practicable software and or a vibration element in them or a connection for it, normally used for alarm, music, awakening or and is portable enough for the use for this application, or otherwise the use (connection) of the/an external vibration element/mask 40, such that the vibrations of the external vibration element are transmitted via the rigid mask to the protrusions, which are in direct contact with the sinuses. The software is created for several options, like the need of and a special time cycle, start and stop, delay or fading, recording, vibration intensity and a converting system from message to application, making it possible to receive, and send it (as mail or text or program) to the user when they like to use the application/invention. The software will be developed if possible for high intelligent devices and less intelligent devices, to reach the highest number of users possible. A mobile intelligent device, can be used freely with or without silicone vibration transmitter/mask or attached elements. Without the silicone vibration transmitter the mobile intelligent device 41, will be placed direct to hold to the face, and place of the sinuses by hand, or when they lay down, direct on the front head and or nose of the user. Besides direct placing of the mobile intelligent device on the head, this application and method include a silicone vibration transmitter/mask with increased silicone platforms, that can be placed on the front head of the user, making the use more easy to handle. With the silicone vibration transmitter between the mobile intelligent device and the head of the user, can be placed horizontal on the face when lay down, and or vertically when the user sits or stand, using the head strap. The mobile phone will be hold by the silicone vibration strap/transmitter on the face (FIGS. 6 and 7.) this way the user will have his hand(s) comfortable free.

The invention of the humming/vibrating, software application (APP) in or on a mobile intelligent device is therefore new, that a mobile intelligent device due to this application and method now also can be used to activate the places in the head, where the sinuses are located and thus more intense can produce NO (nitric oxide) with, and when needed with the silicone vibration transmitter and or integrated nostril dilators what enhance an optimal production and absorption of NO (nitric oxide)and the optimal benefit by inhaling air through the nose what can be important and for a extra effect of the NO (nitric oxide)on the body and mind.

The frequency of the vibration element(s) should not be less or higher then between the 100 and 300 Hz./Hertz, vibration per second, as this is the best frequency for the production of the NO, research learned. But when using a different frequency there will be also a positive effect but less intense, but always better then silence breathing, thus in Principe all frequencies are useful in this invention. In the event the use of an external attached vibration element is needed, (FIG. 8) the element can run on the software, and power of the mobile device. When needed the external device/mask can be produced with an own intern power supply like a battery, to avoid, “over use” of the power supply of the mobile device. Also a combination from both is possible. This invention includes also the preferred software to change the frequency (speed/hertz) if needed and or if possible, if the vibration element in the device needs a change, by slightly slower or faster (higher or lower frequency) The software and application, can be developed by a specialist or software programmer or company, who is specialist in this mobile software. The software will be low in program memory, and will fulfill as many functions as mentioned in this patent, like time cycle, activation, converting possibilities, control of and changing of vibration fade in/out, insensitivity, counter timing and registration of use(s).

Not only the frequency of the vibration itself is important but also the length of time (time cycle) of the vibration. After a certain time of approximately 90 to 120 seconds, it is advisable to give the sinuses rest for a short time, approximately 180 till 220 seconds, to achieve a new start of a new maximal production of NO, by the sinuses, research learned. By a constant and continue vibration, without the mentioned and right interval, the level of quantity of NO (nitric oxide) will become stable and will come down 60 to 80%, and the released NO (nitric oxide) is not optimal. This invention has integrated the exact procedures and the exact time of vibration, and will fade/switch on and off in a way for optimal release and comfort. Many people breathe through the nose and mouth and mouth or nose alone. Nose breathing is a very important as subject in the invention, as breathing through the mouth will bring not the desired result in inhaling the NO, activated by vibration. Only approximately 4 to 5% of the NO, will reach the lungs while breathing by the mouth. Therefore breathing through the nose is highly important part of this invention, as activating of the sinuses alone, will not resulting in the desired effect. Nose breathing is a must and brings approximately 94% of the produced NO in to the lungs. This invention has integrated in the Humming-Mask invention, a double nose dilator (for the left and the right nostril) possibly made from the material, medical silicone or from a different material with vibration elements advisable, but in both or all cases the nose dilator will be a significant element of this invention. Beside the function of breach the nostrils by using the dilators, the dilators can have also the function as a producer of “under pressure” that is needed for a temporarily sucking function on sinus Ostia, to help to open the ostia, the connection between the cavities of the sinuses and the nostrils.

Due to activating the sinuses on the right spots on/in the head of the user, with the right vibration and the right frequency, the production of NO (nitric oxide)is faster and higher. With or by receiving vibrating massages in general, the user will experience a relaxation feeling, and are more or less forced to relax especially when light massage/vibration is taking place on the face. As this invention can also be used to improve the manner of sleeping, by bypassing the first, second and third sleep periods in the sleep cycle, to direct the brain direct in to the “REM” sleep, it is advisable to use this mask only when lay down or sit comfortable. The vibration of the mobile intelligent programmable device produces a Higher NO (nitric oxide) as neurotransmitter and makes the user sharper and more alert or when preferred more relaxed. This is up to the user, as the NO works like that. If needed with the silicone vibration transmitter or attached external element, we can lay down on our back of side, while the vibrating is activating the exact spots/locations. The preferred humming cycle will be 18 to 24 minutes, two times, or even more as desired.

The time needed for producing NO (nitric oxide) with a Humming mobile intelligent programmable device, is much shorter due to activating the exact spots in the face, compared by natural humming and or other vibration devices mend for this purpose. Therefore it also can be used quick, in the office or home in day time when the time for production of NO (nitric oxide) can be important, (like the use as an neuro transmitting boost) as the time in some cases is less and for some people expensive. As many researches shows and medical backed-up a higher amount of NO (nitric oxide) can be important for many health issues for body and mind, we also know, that the exact period of vibration like humming is important to follow, as this create the quantity of NO (nitric oxide) gases as important part in this invention. Detailed description of the use of vibration using a mobile device and or a mobile device including a flexible mask. The drawing FIG. 6. shows the silicone vibration element transmitter on the head of a human being (side ways). The mobile device direct, or with external vibrating elements (FIG. 8.) attached to the mobile device direct, or external vibrating elements, with a wire or wireless by for example blue tooth, is placed on the face or just above the nose and on the fore head sinuses.

The device direct, or external vibrating elements (flexible mask) is connected against the head to create a strong contact to make the bone of the scalp vibrating and with that the sinuses. In FIG. 6 is the mobile device 41, or external vibrating element, clamped/placed in vertical position in the transmitter/strap. The vibrations of this mobile device 41 are transmitted via the mask body to the protrusions on the inside of the mask (not shown), which are in direct contact with the face of the user. 42 is the view of the silicone vibration transmitter. 43 shows the adjustable connection of the vibration transmitter. The vibration transmitter, is in this sample produced of silicone, but the transmitter or strap, can be also produced of any material that can present the job as transmitter, like elastic rubber band, with or without plastic or nylon parts etc. For possible production we can think of silicone, textile, plastic, metal or a combination of that, based on the modern design of on the designer. The head strap 42 can be used while user is sitting vertically, and the transmitter without strap when the user is laying down, more horizontal. The nasal dilator 44 can be used by the user when needed as, the nasal obstruction is a blocking for free breathing, and or as under pressure creator. This is an option in the completing of the invention, as many people (over the 40%) suffer from paranasal obstruction, special due the low level of Nitric oxide, in the body.

FIG. 7. shows a front view of the device 41 according to FIG. 6. 41 is pointing to the mobile device direct, or external vibrating elements, horizontally placed. 42 is pointing to the view of the silicone vibration transmitter with the place/clamp where the mobile device can be placed. 44 is also pointing to the nasal dilator, which can be used by the user when needed as, the nasal obstruction is a blocking for free breathing.

FIG. 8 shows a fifth embodiment 50 of a face mask according to the invention. The vibration elements 51 in the mask/strap 52 are small vibrator elements melted in the silicon mask as increased higher plateaus as optimal vibration transmitters, connected with the wires 54 to an intelligent (smart) mobile device. Or the increased higher plateaus are passive vibrator elements, which conduct the vibrations of a central vibrations means attached to the face mask. Adjustable and or flexible ear rings 53 or endless strap, will hold the Mask in place using the ears or head.

In all cases, direct face mask with time controller or as an intelligent APP, for smart phone or smart mobile product, app software is needed. This software is needed for the invention, mask or strap, working in combination with a intelligence mobile device or as time controller. This (APP) software is based on the same way as the normal controller (cycle and frequency) making the humming mask working, as also explained in this invention. This underlying software is usable for any intelligent mobile device software. The software controls the flow and gives a stream from 1 to 9, extendable with more functions, as recording, comparing etc. when desired. The simple explanation of the routing of the software, from the moment of activation to the working position; the schedule/software or flow control diagram will be an example for the software builder. This application need to work integrated in/to many different O.S., (operating systems/control systems). Activation of the control flows must be possible, depending on the structure, and software of the different devices used. (Android, MS, Nokia, Apple or different) today implementation is possible on all different software languages using the right knowledge and needed conversions to build. As the inventor of this invention is hold to the basic explanation of the invention, (many software languages' are available, a producer of this invention is free to develop the needed software wider and deeper and further than the needed basic parameters as they all pointed to the required time cycle(s) and periods, and software making the vibration elements running, like in the basic mask with an external controller. The basic routing for this software runs from 1 to 9 the following route; 1. The user can start the program in the mobile device as new app(s). 2. The program is searching for the components and receiver information making the program working. 3. After finding the needed parameters in the program for conversion, time, frequency and control, the program will start working and the display shows all needed info to the user. 4. The user select the desired time lap(s), what is in the software available and what is shown on the display. 5. The software now will start the vibration in time with interval(s), as explained under the time cycle, timing, frequency, intensity etc. start working. 6. The software is working and collecting the information for later or additional information to the user, date of use, time of use, user 1. or 2. or 3. etc. place for medical and personal information, as for example to control the changed Blood pressure, the information of cholesterol level, the height of oxygen level, height of Nitric oxide etc. etc. 7. The program will show the collected information to be manipulated and used by the user. 8. The software will secure all controller information. 9. The software will ending.

The manufacture of the software for this application/invention, will shorten or build-out the functions in the program, needed to make it run on different mobile applications, old and new, and as implemented in different hardware/software, updating, and renewed as needed.

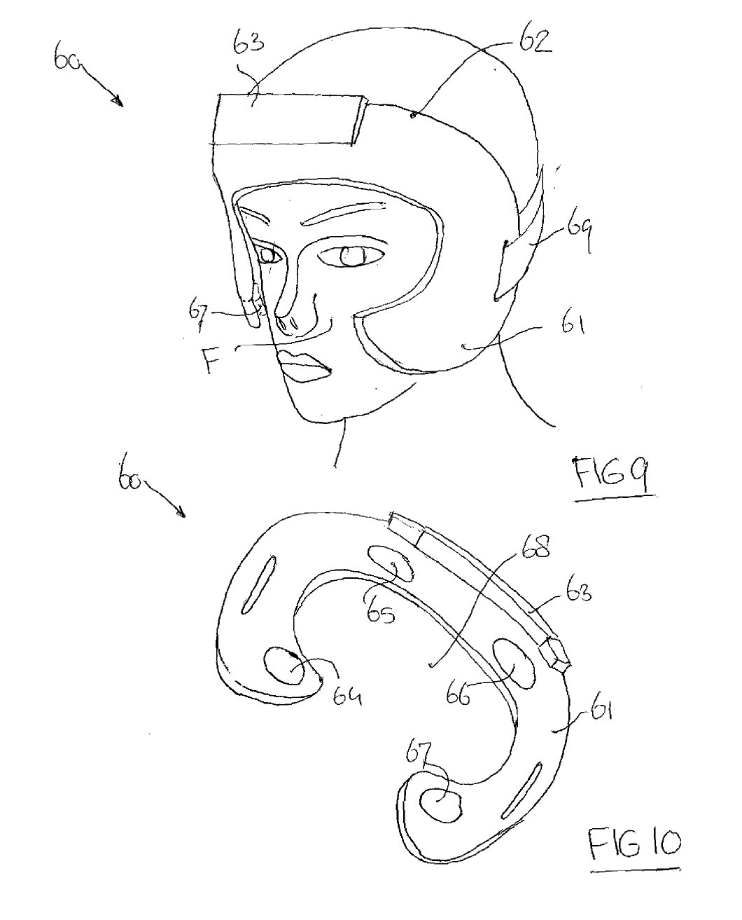

FIG. 9 shows a sixth embodiment of the face mask 60 according to the invention. The face mask 60 has a rigid shell like body 61 adapted to fit over the face F of a user. At the top side 62 vibration means 63 are arranged.

On the inner side of the body 61 (see FIG. 10) a number of protrusions 64, 65, 66, 67 are arranged around an opening 68, through which the user can look when wearing the face mask 60. The protrusions 64, 65, 66, 67 will be in contact with the user's face such that vibrations of the vibration means 63 are transmitted via the rigid shell like body 61 and the protrusions 64, 65, 66, 67 into the sinuses to stimulate the generation of nitric oxide.

A strap 69 is furthermore provided which can be worn around the back of the user's head to secure the body 61 to the face of the user.

1. A face mask comprising:
a body adapted to fit over at least a part of the face of a user, wherein the body has at least a top side, a bottom side and a plane of reference extending in a vertical direction from the top side to the bottom side;
at least one protrusion for contacting the face of the user, which at least one protrusion is arranged at the body;
vibration means arranged in vibrating contact to the body, wherein the vibrations of the vibration means are transmitted by the body to the at least one protrusion; and
securing means arranged to the body for securing the body to the face of the user.

2. The face mask according to claim 1, wherein at least two primary protrusions are arranged each on one side of the plane of reference and near the top edge of the body for contacting the frontal sinuses of the user.

3. The face mask according to claim 1, wherein at least two secondary protrusions are arranged each on one side of the plane of reference and near the bottom edge of the body for contacting the maxillary sinuses of the user.

4. The face mask according to claim 1, wherein at least two tertiary protrusions are arranged each on one side of the plane of reference for contacting the ethmoid sinuses of the user.

5. The face mask according to claim 1, wherein the plane of reference is the plane of symmetry.

6. The face mask according to claim 1, wherein the body is a rigid shell.

7. The face mask according to claim 6, wherein the at least one protrusions is arranged on the inside of the shell.

8. The face mask according to claim 7, wherein the height of the at least one protrusion is adjustable.

9. The face mask according to claim 1, wherein the body comprises at least one central opening for providing a free view by the user.

10. The face mask according to claim 2, wherein the primary protrusions are arranged between the at least one central opening and the top side.

11. The face mask according to claim 3, wherein the secondary protrusions are arranged between the at least one central opening and the bottom side.

12. The face mask according to claim 4, wherein a bridge part is arranged extending over the central opening and wherein the tertiary protrusions are arranged on the bridge part.

13. The face mask according to claim 1, further comprising control means for controlling the vibration means to generate vibrations according to a desired pattern.

14. The face mask according to claim 1, further comprising nose dilators arranged to the body.

15. The face mask according to claim 14, wherein the nose dilators are tube shaped elements for insertion into a nostril.

16. The face mask according to claim 9, wherein the primary protrusions are arranged between the at least one central opening and the top side.

17. The face mask according to claim 9, wherein the secondary protrusions are arranged between the at least one central opening and the bottom side.

18. The face mask according to claim 9, wherein a bridge part is arranged extending over the central opening and wherein the tertiary protrusions are arranged on the bridge part.
